(19) United States
(12) Patent Application Publication
(10) Pub. No.: US 2023/0279227 A1
(43) Pub. Date: Sep. 7, 2023

(54) HALOGENATED POLYPHENYLENE SULFIDE RESIN, RESIN COMPOSITION, MOLDED ARTICLE, AND VIBRATION-DAMPING AGENT FOR RESIN

(71) Applicant: Kureha Corporation, Tokyo (JP)

(72) Inventors: Daisuke MURANO, Tokyo (JP); Haruki MOKUDAI, Tokyo (JP); Yoshinori SUZUKI, Tokyo (JP)

(73) Assignee: Kureha Corporation, Tokyo (JP)

(21) Appl. No.: 18/005,773

(22) PCT Filed: Jul. 15, 2021
(86) PCT No.: PCT/JP2021/026578

§ 371 Date: Jan. 17, 2023

(30) Foreign Application Priority Data
Jul. 22, 2020 (JP) 2020-125534

(51) Int. Cl. C08L 81/02

(52) U.S. Cl. CPC C08L 81/02

(57) ABSTRACT

Provided are: a halogenated polyphenylene sulfide resin that can make a resin vibration-damping without use of a filler when added to the resin; a resin composition containing the halogenated polyphenylene sulfide resin and another resin; a molded article formed of the resin composition; and a vibration-damping agent for a resin, the vibration-damping agent containing the halogenated polyphenylene sulfide resin. A halogenated polyphenylene sulfide resin is used as a component to make a resin vibration-damping in a resin composition. The halogenated polyphenylene sulfide resin is produced by polycondensation reaction of a halogenated benzene and an alkali metal sulfide. The halogenated benzene is a dihalobenzene and/or a trihalobenzene. A ratio of a mass of the trihalobenzene to a mass of the halogenated benzene being 50 mass % or greater.

### TECHNICAL FIELD

The present invention relates to a halogenated polyphenylene sulfide resin, a resin composition containing the halogenated polyphenylene sulfide resin and another resin, a molded article formed of the resin composition, and a vibration-damping agent for a resin, the vibration-damping agent containing the halogenated polyphenylene sulfide resin.

### BACKGROUND ART

A polyarylene sulfide resin (PAS), represented by polyphenylene sulfide resin (PPS), is an engineering plastic having excellent heat resistance, chemical resistance, flame retardancy, mechanical strength, electrical characteristics, dimensional stability, and the like. PAS can be formed into various molded articles, films, sheets, fibers, and the like by ordinary melt processing methods, such as extrusion molding, injection molding, and compression molding. For this reason, PPS has been widely used in a wide range of technical fields such as electric devices, electronic devices, devices for automobiles, and packaging materials.

Among the applications of the PAS described above, improvement in vibration damping properties has been demanded for quietening down, for example, home electrical appliances having compressors and motors such as vacuum cleaners, refrigerators, and air conditioners, and motor components and peripheral components for motors in electric vehicles and hybrid electric vehicles.

In the related art, examples of the resin composition having excellent vibration damping properties include a polyamide resin composition containing plate-like fillers or acicular fillers (see Patent Document 1) and an emulsion resin composition for a vibration-damping material (Patent Document 2).

### CITATION LIST

### Patent Literature

Patent Document 1: JP 2016-089149 A
Patent Document 2: JP 2012-126775 A

### SUMMARY OF INVENTION

### Technical Problem

However, the resin composition described in Patent Document 1 essentially contains fillers and thus cannot be used for fillerless uses. Furthermore, the emulsion resin composition for a vibration-damping material described in Patent Document 2 has difficulty in application to a molding method for ordinary resins, such as press molding, extrusion molding, and injection molding, because of being an emulsion resin composition.

In response to the above issue, it is an object of the present invention is to provide: a poly(halophenylene)sulfide resin that can make a resin vibration-damping without use of a filler when added to the resin; a resin composition containing the poly(halophenylene)sulfide resin and another resin; a vibration-damping material formed of the resin composition; a molded article formed of the resin composition or the vibration-damping material; and a vibration-damping agent for a resin, the vibration-damping agent containing the poly(halophenylene)sulfide resin.

### Solution to Problem

The present inventors have found that the above issue can be solved by using a poly(halophenylene)sulfide resin, which is a polycondensation product of trihalobenzene and an alkali metal sulfide, as a component to make a resin vibration-damping in a resin composition, and thus have completed the present invention.

The halogenated polyphenylene sulfide resin according to an aspect of the present invention includes a polycondensation product of a halogenated benzene and an alkali metal sulfide.

The halogenated benzene is a dihalobenzene and/or a trihalobenzene. A ratio of a mass of the trihalobenzene to a mass of the halogenated benzene is 50 mass % or greater. The halogenated benzene contains one to three halogen atoms selected from the group consisting of fluorine, chlorine, bromine, and iodine.

The resin composition according to an aspect of the present invention contains the halogenated polyphenylene sulfide resin described above and another resin other than the halogenated polyphenylene sulfide resin.

In the resin composition described above, a ratio of a mass of the halogenated polyphenylene sulfide resin to a total of the mass of the halogenated polyphenylene sulfide resin and a mass of thermoplastic resin may be 1 mass % or greater and 30 mass % or less.

In the resin composition described above, a ratio of a mass of the halogenated polyphenylene sulfide resin to a total of the mass of the halogenated polyphenylene sulfide resin and a mass of the other resin may be greater than 30 mass % and 90 mass % or less.

In the resin composition described above, the other resin may be a thermoplastic resin.

In the resin composition described above, the thermoplastic resin may be a polyarylene sulfide resin.

A molded article according to an aspect of the present invention contains the resin composition described above.

A vibration-damping agent for a resin according to an aspect of the present invention contains the halogenated polyphenylene sulfide resin described above.

### ADVANTAGEOUS EFFECTS OF INVENTION

According to the present invention, a halogenated polyphenylene sulfide resin that can make a resin vibration-damping without use of a filler when added to the resin; a resin composition containing the halogenated polyphenylene sulfide resin and another resin; a molded article formed of the resin composition; and a vibration-damping agent for a resin, the vibration-damping agent containing the halogenated polyphenylene sulfide resin, can be provided.

### BRIEF DESCRIPTION OF THE DRAWINGS

FIG. 1 is a graph showing an FT-IR measurement result of a halogenated polyphenylene sulfide resin produced in Example 1.

### DESCRIPTION OF EMBODIMENTS

Halogenated Polyphenylene Sulfide Resin

The halogenated polyphenylene sulfide resin is a polycondensation product of a halogenated benzene and an alkali metal sulfide. The halogenated benzene is a dihalobenzene and/or a trihalobenzene. The ratio of the mass of the trihalobenzene to the mass of the halogenated benzene is 50 mass % or greater.

The halogenated benzene contains one to three halogen atoms selected from the group consisting of fluorine, chlorine, bromine, and iodine.

As the halogen atom in the halogenated benzene, a chlorine atom is preferred from the perspectives of reactivity in polycondensation of the halogenated halobenzene and availability of the halogenated halobenzene. That is, as the halogenated benzene, dichlorobenzene and trichlorobenzene are preferred.

The halogenated polyphenylene sulfide resin is not limited to a straight-chain polymer in which halophenylene groups or phenylene groups and sulfur atoms are alternately bonded. Typically, the halogenated polyphenylene sulfide resin contains a branched structure formed by reacting all three halogen atoms contained in the trihalobenzene with alkali metal sulfides, in the molecular chain.

Preferred specific examples of the trihalobenzene include 1,2,3-trichlorobenzene, 1,2,4-trichlorobenzene, and 1,3,5-trichlorobenzene. Among these, 1,2,4-trichlorobenzene is preferred from the perspective of reactivity in polycondensation. Thus, the trihalobenzene preferably contains 1,2,4-trichlorobenzene, and all the trihalobenzene is more preferably 1,2,4-trichlorobenzene.

In a case where the trihalobenzene contains 1,2,4-trichlorobenzene, the ratio of the mass of 1,2,4-trichlorobenzene to the mass of the trihalobenzene is preferably 70 mass % or greater, more preferably 80 mass % or greater, even more preferably 90 mass % or greater, yet even more preferably 95 mass % or greater, and most preferably 100 mass %.

Preferred specific examples of the dihalobenzene include p-dichlorobenzene, m-dichlorobenzene, and o-dichlorobenzene. Among these, p-dichlorobenzene is preferred from the perspectives of easy availability and low cost, and excellent processability and mechanical properties of the resulting halogenated polyphenylene sulfide resin.

Note that, depending on the production method, the trihalobenzene may contain a dihalobenzene as an impurity. Such trihalobenzene containing a dihalobenzene as an impurity can be preferably used as a raw material of the halogenated polyphenylene sulfide.

In this case, in the trihalobenzene containing a dihalobenzene as an impurity, the purity of the trihalobenzene is preferably 90 mass % or greater and 99.9 mass % or less and the content of the dihalobenzene is preferably 0.1 mass % or greater and 10 mass % or less; and the purity of the trihalobenzene is more preferably 95 mass % or greater and 99.9 mass % or less and the content of the dihalobenzene is more preferably 0.1 mass % or greater and 5 mass % or less.

From the perspective of excellent vibration damping performance of the halogenated polyphenylene sulfide resin, the ratio of the mass of the trichlorobenzene to the total of the mass of the trichlorobenzene and the mass of the dichlorobenzene used in production of the halogenated polyphenylene sulfide resin is preferably 70 mass % or greater, more preferably 90 mass % or greater, and even more preferably 100 mass %.

Examples of the alkali metal sulfide include lithium sulfide, sodium sulfide, potassium sulfide, rubidium sulfide, and cesium sulfide. Among these, sodium sulfide and potassium sulfide are preferred, and sodium sulfide is more preferred. The alkali metal sulfide as a sulfur source can be handled in a form of, for example, a water-based slurry or an aqueous solution.

The method of polycondensation reaction of the halogenated benzene and the alkali metal sulfide is not particularly limited, and a method that is the same as or similar to known methods of producing polyarylene sulfide can be appropriately employed.

An example of the preferred method includes a method of polymerizing a halogenated benzene and an alkali metal sulfide by heating in the presence of a solvent.

When the halogenated benzene and the alkali metal sulfide are reacted, the amount of the halogenated benzene to be used is not particularly limited as long as a halogenated polyphenylene sulfide resin having desired characteristics can be produced.

The amount of the halogenated benzene to be used is preferably 1.30 mol or greater and 1.90 mol or less, more preferably 1.40 mol or greater and 1.80 mol or less, and even more preferably 1.50 mol or greater and 1.70 mol or less, with respect to 1 mol of charged alkali metal sulfide as a sulfur source. By using the trihalobenzene in the amount described above, a halogenated polyphenylene sulfide resin having a high molecular weight to a desired degree tends to be produced.

The solvent is not particularly limited as long as the polycondensation reaction suitably proceeds. The solvent is preferably an organic polar solvent from the perspective of excellent solubility and dispersibility of raw material compounds, oligomers, and produced polymers.

Examples of the organic polar solvent include: organic amide solvents; aprotic organic polar solvents formed from organosulfur compounds; and aprotic organic polar solvents formed from cyclic organophosphorus compounds. Examples of the organic amide solvent include: amide compounds, such as N,N-dimethylformamide and N,N-dimethylacetamide; N-alkylcaprolactam compounds, such as N-methyl-ε-caprolactam; N-alkylpyrrolidone compounds or N-cycloalkylpyrrolidone compounds, such as N-methyl-2-pyrrolidone (hereinafter, also referred to as “NMP”) and N-cyclohexyl-2-pyrrolidone; N,N-dialkylimidazolidinone compounds, such as 1,3-dialkyl-2-imidazolidinone; tetraalkyl urea compounds, such as tetramethyl urea; and hexaalkylphosphorus triamide compounds, such as hexamethylphosphorus triamide. Examples of the aprotic organic polar solvent formed from an organosulfur compound include dimethyl sulfoxide and diphenyl sulfone. Examples of the aprotic organic polar solvent formed from a cyclic organophosphorus compound include 1-methyl-1-oxophosphorane. Among them, from the viewpoint of availability, handleability, and the like, an organic amide solvent is preferable, an N-alkylpyrrolidone compound, an N-cycloalkylpyrrolidone compound, an N-alkylcaprolactam compound, and an N,N-dialkylimidazolidinone compound are more preferable, NMP, N-methyl-ε-caprolactam, and 1,3-dialkyl-2-imidazolidinone are still more preferable, and NMP is particularly preferable.

The amount of the solvent to be used is preferably 1 mol or greater and 30 mol or less, and more preferably 3 mol or greater and 15 mol or less, with respect to 1 mol of the alkali metal sulfide as a sulfur source from the perspective of efficiency of polymerization reaction and the like.

In the reaction solution to be fed to the polycondensation reaction, an alkali metal hydroxide may be charged together with the halogenated benzene and the alkali metal sulfide. Examples of the alkali metal hydroxide include lithium hydroxide, sodium hydroxide, potassium hydroxide, rubidium hydroxide, and cesium hydroxide.

It has been proved that the method of reacting the sulfur source with the trihalobenzene in the presence of the alkali metal hydroxide is suitable for producing a halogenated polyphenylene sulfide resin having excellent balance of various properties.

The amount of the alkali metal hydroxide to be used is not particularly limited in a range that does not impair the object of the present invention. The amount of the alkali metal hydroxide to be used is typically preferably 0.01 mol or greater and 0.1 mol or less, and more preferably 0.03 mol or greater and 0.08 mol or less, with respect to 1 mol of the alkali metal sulfide as a sulfur source.

In the reaction solution to be fed to the polycondensation reaction, water may be charged together with the halogenated benzene and the alkali metal sulfide. By using water, the alkali metal sulfide and the alkali metal hydroxide can be made into a solution form in the reaction system.

The amount of the water to be used is not particularly limited in a range that does not impair the object of the present invention. The amount of the water to be used is typically preferably 1.0 mol or greater and 2.5 mol or less, and more preferably 1.2 mol or greater and 2.3 mol or less, with respect to 1 mol of the alkali metal sulfide as a sulfur source.

After the components described above are mixed, the mixture was fed to a polycondensation reaction as a reaction solution. The polycondensation reaction may be performed in the air; however, from the perspectives of suppressing decomposition and coloring of the product, suppressing deterioration of the solvent, and the like, the polycondensation reaction is preferably performed in an inert gas atmosphere. The inert gas is not particularly limited and is preferably a nitrogen gas, a helium gas, or the like, and more preferably a nitrogen gas.

The polycondensation reaction may be performed batchwise, or may be performed in a continuous manner.

From the perspective of efficiency of the polycondensation reaction and the like, the temperature at which the polycondensation reaction is performed is preferably 140° C. or higher and 300° C. or lower, more preferably 150° C. or higher and 280° C. or lower, and even more preferably 160° C. or higher and 265° C. or lower.

The reaction time is not particularly limited, and time that proceeds the polycondensation reaction to a desired degree is appropriately selected. Typically, the reaction time is preferably 0.5 hours or longer and 12 hours or less, and more preferably 1 hour or longer and 6 hours or less.

After the polycondensation reaction was performed as described above, a halogenated polyphenylene sulfide resin is recovered from the reaction solution.

Typically, after the reaction solution is cooled down to a temperature at, for example, 0° C. or higher and 50° C. or lower, and preferably approximately 10° C. or higher and 40° C. or lower, which is around the room temperature, the crude article of the halogenated polyphenylene sulfide resin contained in the cooled reaction solution is washed and recovered.

The crude article of the halogenated polyphenylene sulfide resin is washed by a known method. An example of the washing method includes a method in which washing by acetone and washing by water are performed in this order. In this case, acetone used for washing may contain, for example, 10 mass % or less, and preferably approximately 5 mass % or less, of water. For the washing by acetone and water, the halogenated polyphenylene sulfide resin is preferably washed by an acetic acid aqueous solution. The concentration of the acetic acid aqueous solution is not particularly limited and is, for example, 0.05 mass % or greater and 5 mass % or less, and may be 0.1 mass % or greater and 2 mass % or less.

The temperature condition in a case of performing the washing described above is not particularly limited as long as a desired washing effect can be achieved. The temperature at which the washing operations described above are performed may be, for example, 0° C. or higher and 80° C. or lower, 10° C. or higher and 60° C. or lower, or 20° C. or higher and 50° C. or lower.

By drying the halogenated polyphenylene sulfide resin washed as described above as needed, the halogenated polyphenylene sulfide resin is produced.

From the perspectives of vibration damping performance and processability, the glass transition temperature (Tg) of the halogenated polyphenylene sulfide resin produced by the method described above is preferably in a range of 80° C. or higher and 130° C. or lower. Furthermore, the weight average molecular weight (Mw) is preferably 1000 or greater and 5000 or less.

Resin Composition

The halogenated polyphenylene sulfide resin described above is preferably used by being mixed with another resin other than the halogenated polyphenylene sulfide resin. By mixing and using the halogenated polyphenylene sulfide resin with the other resin, vibration damping properties of the other resin can be improved.

As the other resin, a curable resin or a thermoplastic resin may be used. Because of ease in uniform mixing of the halogenated polyphenylene sulfide resin and the other resin, the other resin is preferably a thermoplastic resin.

As the curable resin, a precursor of an uncured curable resin can be also used. The curable resin may be a thermosetting resin or a photocurable resin, and a thermosetting resin is preferred from the perspective of, for example, ease in producing a molded article having a large size. An example of the method of mixing the curable resin and the halogenated polyphenylene sulfide resin includes a method in which a halogenated polyphenylene sulfide resin in a powder or particle form is mixed with a precursor of an uncured curable resin in a liquid or solution form and, after the mixing, the solvent is removed as needed. In this case, depending on the type of the curable resin, a curing agent may be blended in the mixture.

The mixture prepared as described above is formed into a resin composition by being cured by heating and/or exposure using a method based on the type of the curable resin.

Specific examples of the curable resin include: thermosetting resins such as phenol resins, melamine resins, epoxy resins, and alkyd resins; and photocurable resins such as (meth)acrylic resins.

In a case where the other resin is a curable resin, the ratio of the mass of the halogenated polyphenylene sulfide resin to the total of the mass of the halogenated polyphenylene sulfide resin and the mass of the other resin is, for example, preferably 1 mass % or greater and 90 mass % or less, and more preferably 5 mass % or greater and 50 mass % or less.

In a case where the other resin is a thermoplastic resin, the poly(halophenylene)sulfide resin and the other resin are typically mixed by using a melt-kneading apparatus such as a single screw extruder or a twin screw extruder. The mixing conditions are not particularly limited and are appropriately decided taking the melting point, melt viscosity, and the like of the poly(halophenylene)sulfide resin and the other resin into consideration.

Preferred examples in a case where the other resin is a thermoplastic resin include polyacetal resins, polyamide resins, polycarbonate resins, polyester resins (e.g., polybutylene terephthalate, polyethylene terephthalate, polyarylate resins, and liquid crystalline polyester resins), FR-AS resins, FR-ABS resins, AS resins, ABS resins, polyphenylene oxide resins, polyarylene sulfide resins, polysulfone resins, polyether sulfone resins, polyether ether ketone resins, fluorine-based resins, polyimide resins, polyamide-imide resins, polyamide-bismaleimide resins, polyetherimide resins, polybenzoxazole resins, polybenzothiazole resins, polybenzimidazole resins, BT resins, polymethylpentene, ultra high molecular weight polyethylene, FR-polypropylene, and polystyrene.

Among these thermoplastic resins, from the perspective of excellent miscibility with the halogenated polyphenylene sulfide resin, a polyarylene sulfide resin is preferred, and a polyphenylene sulfide resin is more preferred. As the polyphenylene sulfide resin, a poly(p-phenylene sulfide) resin, which is a polycondensation product of p-dichlorobenzene and a sulfiding agent (e.g., alkali metal sulfide and alkali metal hydrosulfide), is preferred.

Furthermore, from the perspective of ease in producing a resin composition having excellent vibration damping properties, the polyphenylene sulfide resin is preferably a combination of poly(p-phenylene sulfide) resin and poly(m-phenylene sulfide) resin. The poly(m-phenylene sulfide) resin is typically a polycondensation product of m-dichlorobenzene and a sulfiding agent (e.g., alkali metal sulfide and alkali metal hydrosulfide).

The polyarylene sulfide resin is not particularly limited and can be appropriately selected from known polyarylene sulfide resins. For the polyarylene sulfide resin that is blended with the halogenated polyphenylene sulfide resin, the melting point is preferably 270° C. or higher and 300° C. or lower, the weight average molecular weight (Mw) is preferably 1000 or greater and 100000 or less, and the melt viscosity measured at a temperature of 310° C. and at a shear rate of 1200 sec⁻¹ is preferably 100 Pas or greater and 250 Pas or less.

The ratio of the mass of the poly(halophenylene)sulfide resin to the total of the mass of the halogenated polyphenylene sulfide resin and the mass of the other resin (especially, thermoplastic resin) is preferably 1 mass % or greater and 30 mass % or less, more preferably 3 mass % or greater and 25 mass % or less, and even more preferably 5 mass % or greater and 20 mass % or less, from the perspective of processability of the resin composition.

The ratio of the mass of the halogenated polyphenylene sulfide resin to the total of the mass of the halogenated polyphenylene sulfide resin and the mass of the other resin (especially, thermoplastic resin) is preferably greater than 30 mass % and 90 mass % or less, more preferably 50 mass % or greater and 85 mass % or less, and even more preferably 60 mass % or greater and 80 mass % or less, from the perspective of vibration damping properties of the resin composition.

The resin composition described above may contain, as needed, additives or additive materials that are blended in various resin compositions in the related art, and examples of the additives or additive materials include colorants, plasticizers, antioxidants, UV absorbers, flame retardants, release agents, fillers, and reinforcing materials. These additives or additive materials are used in an amount that is in an appropriate range based on the type of the additives or additive materials.

Vibration-Damping Material

The resin composition described above is suitably used as a vibration-damping material. In the specification and claims of the present application, specifically, a material having a coefficient of loss (tan 6) of 0.150 or greater is considered as a vibration-damping material, and the coefficient of loss is measured by dynamic viscoelastic measurement. The coefficient of loss of the vibration-damping material is preferably 0.170 or greater, and more preferably 0.200 or greater.

Molded Article

The resin composition or the vibration-damping material described above is formed into molded articles having various shapes by an appropriate method corresponding to the type of the other resin and suitably used.

In a case where the other resin is a curable resin, for example, the resin composition in an uncured state may be charged in a mold having a recess of a desired shape, and then the resin composition formed into a desired shape in the mold may be cured.

Furthermore, in a case where the resin composition containing the curable resin in an uncured state is in a liquid form, a molded article in a desired shape can be also produced by a 3D printing method. In this case, the resin composition may be appropriately cured in the middle of the molding, and the molded article may be cured after the molded article in the desired shape is prepared.

In a case where the other resin is a thermoplastic resin, typically, the resin composition is molded by an ordinary method such as press molding, extrusion molding, and injection molding.

The use of the molded article is not particularly limited. Specific examples of the use of the molded article include components of devices generating vibration, such as transport vehicles including vehicles such as automobiles and two-wheeled vehicles, ships, railways, and aircraft, or peripheral components of the devices; components of devices for which reduction of vibration is desired, such as seats and peripheral components of seats, and controls of the transport vehicles; various household electrical appliance components; office automation equipment components; construction materials; machine tool components; and industrial machine components.

Among the use described above, an example of use of a molded article includes components of coolant circulation devices in transport vehicles having engines, such as automobiles. Examples of the component of coolant circulation device include pump housings and pipes for coolant circulation. By using the molded article for the use described above, various products can be made vibration-damping.

Vibration-Damping Agent for Resin

The vibration-damping agent for a resin contains the halogenated polyphenylene sulfide resin described above. The vibration-damping agent may contain only the halogenated polyphenylene sulfide resin, or may contain the halogenated polyphenylene sulfide resin and another component. The other component is not particularly limited, and examples of the other component include colorants, the thermoplastic resins described above, plasticizers, and compatibilizing agents. In particular, by mixing the halogenated polyphenylene sulfide resin in a high concentration in a thermoplastic resin, a masterbatch of the vibration-damping agent can be formed. The masterbatch preferably contains a plasticizer and/or a compatibilizing agent as needed.

The present invention is not limited to the embodiments described above, and various modifications are possible within the scope indicated in the claims. Embodiments obtained by appropriately combining the technical means disclosed by the embodiments are also included in the technical scope of the present invention. In addition, all of the documents described in the present specification are herein incorporated by reference.

### EXAMPLES

The present invention will be more specifically described hereinafter with reference to examples and a comparative example. Note that the present invention is not limited to these examples. The measurement method for the melt viscosity described below is as described above.

### Example 1

In an autoclave having a volume of 1 L and equipped with an agitator, 78.0 g of sodium sulfide, 2.5 g of sodium hydroxide, 374.8 g of N-methyl-2-pyrrolidone (NMP), 27.0 g of ion-exchanged water, and 195.4 g of 1,2,4-trichlorobenzene (purity: 99.8 mass %) were charged. Then, inside of the autoclave was purged with a nitrogen gas atmosphere, and the autoclave was sealed. Thereafter, while the reaction solution in the autoclave was agitated, the reaction solution was heated gradually to 240° C. over approximately 30 minutes. After the polycondensation reaction was performed by maintaining 240° C. for 2 hours, the reaction solution was cooled to approximately room temperature.

After the contents of the autoclave were taken out, 1 L of acetone containing 3 mass % of pure water was added to the contents taken out of the autoclave, and the contents were washed at room temperature for 30 minutes by agitation. After the washed solid content (crude article) was recovered by filtration, the washing operation by acetone described above was repeated for twice.

The solid content washed by the acetone was washed in 1 L of pure water at room temperature for 30 minutes by agitation, and then recovered by filtration. The recovered solid content was repeatedly subjected to the washing operation by the pure water described above for three times, then the solid content recovered by the filtration was dried at 120° C. for 4 hours, and thus a polycondensation product of trichlorobenzene and sodium sulfide was produced as a purified halogenated polyphenylene sulfide resin.

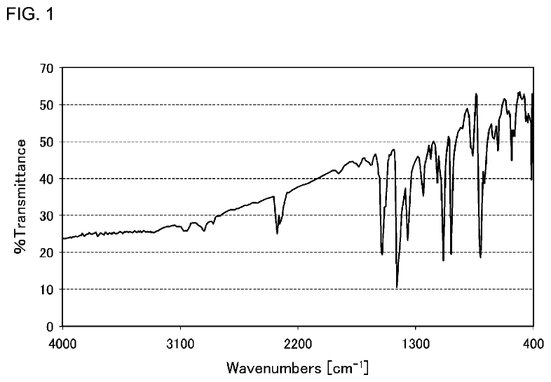

For the halogenated polyphenylene sulfide resin produced, FT-IR measurement by the KBr tablet method was performed. The measurement result is shown in FIG. 1.

Furthermore, the weight average molecular weight (Mw) of the halogenated polyphenylene sulfide resin produced was 3500, and the glass transition temperature was 90° C.

### Preparation Example 1

In an autoclave having a volume of 1 L and equipped with an agitator, 78.0 g of sodium sulfide, 2.5 g of sodium hydroxide, 374.8 g of N-methyl-2-pyrrolidone (NMP), 27.0 g of ion-exchanged water, and 149.9 g of 1,3-dichlorobenzene (m-dichlorobenzene) were charged. Then, inside of the autoclave was purged with a nitrogen gas atmosphere, and the autoclave was sealed. Thereafter, while the reaction solution in the autoclave was agitated, the reaction solution was heated gradually to 240° C. over approximately 30 minutes. After the polycondensation reaction was performed by maintaining 240° C. for 2 hours, the reaction solution was cooled to approximately room temperature.

After the contents of the autoclave were taken out, 1 L of acetone containing 3 mass % of pure water was added to the contents taken out of the autoclave, and the contents were washed at room temperature for 30 minutes by agitation. After the washed solid content (crude article) was recovered by filtration, the washing operation by acetone described above was repeated for twice.

The solid content washed by the acetone was washed in 1 L of pure water at room temperature for 30 minutes by agitation, and then recovered by filtration. The recovered solid content was repeatedly subjected to washing operation by the pure water described above for three times, then the solid content recovered by the filtration was dried at 120° C. for 4 hours, and thus a poly(m-phenylene sulfide) resin was produced. The weight average molecular weight (Mw) of the produced poly(m-phenylene sulfide) resin was 5000.

### Examples 2 to 7 and Comparative Example 1

In Examples 2 to 6, poly(p-phenylene sulfide) resin (W-214A, available from Kureha Corporation) and the halogenated polyphenylene sulfide resin produced in Example 1 were mixed in a ratio listed in Table 1, and thus resin compositions were produced.

In Example 7, a poly(p-phenylene sulfide) resin (W-214A, available from Kureha Corporation), the poly(m-phenylene sulfide) resin produced in Preparation Example 1, and the halogenated polyphenylene sulfide resin produced in Example 1 were mixed in a ratio listed in Table 1, and thus a resin composition was produced.

Specifically, after the polyphenylene sulfide resin and the halogenated polyphenylene sulfide resin were dry-blended in the ratio listed in Table 1, the mixture was melt-kneaded at a test temperature of 320° C., test time of 5 minutes, and a rotational speed of 100 rpm by using a melt-kneading machine (LABO PLASTOMILL, available from Toyo Seiki Seisaku-sho, Ltd.) equipped with an R60 (volume: 60 mL) barrel and a full flight screw, and thus a resin composition was produced.

In Comparative Example 1, the polyphenylene sulfide resin alone was used as a sample.

For each of Examples 2 to 7 and Comparative Example 1, a sample of the resin composition or the resin alone was subjected to compression molding at 320° C., at 5 MPa for 1 minute, and thus a sheet having a size of 55 mm×55 mm×1 mm was produced. The brittleness of the produced sheet was checked by touch and visual inspection, and thus moldability was evaluated. A case where the strength of the sheet had no problem was evaluated as Excellent, a case where the compression molding was performed but the touch of the sheet indicated slight brittleness was evaluated as Good, and a case where the compression molding could not be performed was evaluated as Poor. Specifically, the case evaluated as Good was a case where the sheet was brittle to the degree that the sheet cracked easily by bending.

Furthermore, the produced sheet was cut into a strip-like test piece for DMA measurement by using a box-cutter, and dynamic viscoelastic evaluation was performed by DMA, and thus a coefficient of loss was measured. Note that, before DMA measurement, the test piece was subjected to annealing treatment at 150° C. for 1 hour. The DMA measurement conditions are as follows. The value of the coefficient of loss is a maximum value of values measured at 20° C. to 240° C. The measurement results of coefficient of loss are shown in Table 1.
DMA Measurement Conditions
Sample size: 10 mm×5 mm×1 mm
Tensile temperature: 20° C. to 240° C.
Temperature increasing rate: 2° C./min
Frequency: 10 Hz

TABLE 1

| | | | | | | | Comparative |
|---|---|---|---|---|---|---|---|
| | Examples | | | | | | Example |
| | 2 | 3 | 4 | 5 | 6 | 7 | 1 |
| Poly(p-phenylene | 90 | 80 | 50 | 20 | 95 | 80 | 100 |
| sulfide) resin | | | | | | | |
| (mass %) | | | | | | | |
| Poly(m-phenylene | — | — | — | — | — | 10 | — |
| sulfide) resin | | | | | | | |
| (mass %) | | | | | | | |
| Halogenated | 10 | 20 | 50 | 80 | 5 | 10 | — |
| polyphenylene | | | | | | | |
| sulfide resin | | | | | | | |
| (mass %) | | | | | | | |
| Moldability | Excellent | Excellent | Good | Good | Excellent | Excellent | Excellent |
| Maximum value of | 0.197 | 0.250 | 0.444 | 0.592 | 0.180 | 0.160 | 0.144 |
| coefficient of loss | | | | | | | |
| at 20° C. to 240° C. | | | | | | | |

From the comparison of Examples 2 to 7 and Comparative Example 1, it was found that, by blending the halogenated polyphenylene sulfide resin in the polyphenylene sulfide resin, the coefficient of loss became remarkably higher and vibration damping properties were improved.

### Example 8

A halogenated polyphenylene sulfide resin was produced in the same manner as in Example 1 except for replacing 1,2,4-trichlorobenzene (purity: 99.8%) with 1,2,4-trichlorobenzene (purity: 97.5 mass %) containing 2.3 mass % of p-dichlorobenzene as an impurity. The weight average molecular weight (Mw) of the produced halogenated polyphenylene sulfide resin was 3500, and the glass transition temperature was 90° C.

The preparation and evaluation of the resin composition was performed in the same manner as in Example 3 except for using the halogenated polyphenylene sulfide resin produced in this way. The evaluation results of the resin composition were the same as or similar to Example 3.

1. A resin composition comprising: a halogenated polyphenylene sulfide resin; and
a resin other than the halogenated polyphenylene sulfide resin,
wherein
a ratio of a mass of the halogenated polyphenylene sulfide resin to a total of the mass of the halogenated polyphenylene sulfide resin and a mass of the other resin is 1 mass % or greater and 30 mass % or less,
the halogenated polyphenylene sulfide resin is a polycondensation product of a halogenated benzene and an alkali metal sulfide,
the halogenated benzene is a dihalobenzene and/or a trihalobenzene,
a ratio of a mass of the trihalobenzene to a mass of the halogenated benzene is 50 mass % or greater, and
the halogenated benzene contains one to three halogen atoms selected from the group consisting of fluorine, chlorine, bromine, and iodine.

2-5. (canceled)

6. The resin composition according to claim 1, wherein the other resin is a polyarylene sulfide resin.

7. A molded article formed from the resin composition described in claim 1.

8. (canceled)

9. The resin composition according to claim 6, wherein the polyarylene sulfide resin is a poly(p-phenylene sulfide) resin.
